(19) United States
(12) Patent Application Publication
(10) Pub. No.: US 2006/0031521 A1
(43) Pub. Date: Feb. 9, 2006

(54) Method for early failure detection in a server system and a computer system utilizing the same

(75) Inventor: Tomasz F. Wilk, Cary, NC (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 10/842,310

(22) Filed: May 10, 2004

(51) Int. Cl. G06F 15/16

(52) U.S. Cl. 709/227

(57) ABSTRACT

A method and system for detecting a failing server of a plurality of servers is disclosed. In a first aspect, the method comprises monitoring load balancing data for each of the plurality of servers via at least one switch module, and determining whether a server is failing based on the load balancing data associated with the server. In a second aspect, a computer system comprises a plurality of servers coupled to at least one switch module, a management module, and a failure detection mechanism coupled to the management module, wherein the failure detection mechanism monitors load balancing data for each of the plurality of servers via the at least one switch module and determines whether a server is failing based on the load balancing data associated with the server.

### FIELD OF THE INVENTION

The present invention relates generally to computer server systems and, more particularly, to a method and system for early failure detection in a server system.

### BACKGROUND OF THE INVENTION

In today's environment, a computing system often includes several components, such as servers, hard drives, and other peripheral devices. These components are generally stored in racks. For a large company, the storage racks can number in the hundreds and occupy huge amounts of floor space. Also, because the components are generally free standing components, i.e., they are not integrated, resources such as floppy drives, keyboards and monitors, cannot be shared.

A system has been developed by International Business Machines Corp. of Armonk, N.Y., that bundles the computing system described above into a compact operational unit. The system is known as an IBM eServer BladeCenter.™ The BladeCenter is a 7U modular chassis that is capable of housing up to 14 individual server blades. A server blade or blade is a computer component that provides the processor, memory, hard disk storage firmware of an industry standard server. Each blade can be “hot-plugged” into a slot in the chassis. The chassis also houses supporting resources such as power, switch, management and blower modules. Thus, the chassis allows the individual blades to share the supporting resources.

For redundancy purposes, two Ethernet Switch Modules (ESMs) are mounted in the chassis. The ESMs provide Ethernet switching capabilities to the blade server system. The primary purpose of each switch module is to provide Ethernet interconnectivity between the server blades, the management modules, and the outside network infrastructure.

The ESMs are higher function ESMs, e.g., OSI Layer 4—Routing layer and above, that are capable of load balancing among different Ethernet ports connected to a plurality of server blades. Each ESM executes a standard load balancing algorithm for routing traffic among the plurality of server blades so that the load is distributed evenly across the blades. This load balancing algorithm is based on an industry standard Virtual Router Redundancy Protocol. This standard does not describe the implementation with the ESM. Such standard algorithms are specific to the implementation and may be based on round robin selection, least connections, or response time.

The BladeCenter's management module communicates with each of the server blades as well as with each of the other modules. Among other things, the management module is programmed to monitor various parameters in each server blade, such as CPU temperature and hard drive errors, in order to detect a failing server blade. When such an impending failure is detected, the management module transmits an alarm to a system administrator so that the failing server blade can be replaced. Nevertheless, because of the inherent time delay between the alarm and the repair, the server blade often fails before it is replaced. When such a failure occurs, all existing connections to the failed blade are immediately severed. A user application must recognize the outage and re-establish each connection. For an individual user accessing the server system, this sequence of events is highly disruptive because the user will experience an outage of service of approximately 40 seconds. Cumulatively, the disruptive impact is multiplied several times if the failed blade was functioning at full capacity, i.e., carrying a full load, before failure.

Accordingly, a need exists for a system and method for early failure detection in a server system. The present invention addresses such a need.

### SUMMARY OF THE INVENTION

The present invention is related to a method and system for detecting a failing server of a plurality of servers. In a first aspect, the method comprises monitoring load balancing data for each of the plurality of servers via at least one switch module, and determining whether a server is failing based on the load balancing data associated with the server. In a second aspect, a computer system comprises a plurality of servers coupled to at least one switch module, a management module, and a failure detection mechanism coupled to the management module, where the failure detection mechanism monitors load balancing data for each of the plurality of servers via the at least one switch module and determines whether a server is failing based on the load balancing data associated with the server.

### BRIEF DESCRIPTION OF THE DRAWINGS

FIG. 1 is a perspective view illustrating the front portion of a BladeCenter.

FIG. 2 is a perspective view of the rear portion of the BladeCenter.

FIG. 3 is a schematic diagram of the server blade system's management subsystem.

FIG. 4 is a topographical illustration of the server blade system's management functions.

FIG. 5 is a schematic block diagram of the server blade system according to a preferred embodiment of the present invention.

FIG. 6 is a flowchart illustrating a process by which the failure detection mechanism operates according to a preferred embodiment of the present invention.

### DETAILED DESCRIPTION

The present invention relates generally to server systems and, more particularly, to a method and system for early failure detection in a server system. The following description is presented to enable one of ordinary skill in the art to make and use the invention and is provided in the context of a patent application and its requirements. Although the preferred embodiment of the present invention will be described in the context of a BladeCenter, various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

According to a preferred embodiment of the present invention, a failure detection mechanism coupled to each of a plurality of switch modules monitors load balancing data collected by the switch modules. In particular, it monitors each server's response time during an initial TCP handshake. Typically, the response time is utilized as a measure of the server's workload, and is used by the switch to perform delay time load balancing. Nevertheless, if the response time exceeds a certain threshold value and if the response time does not improve after the server's workload has been reduced, it can indicate that the server is beginning to fail. Accordingly, by monitoring the response times for each of the plurality of servers, the failure detection mechanism can detect a failing server early and initiate protective and/or preventive measures long before the server actually fails.

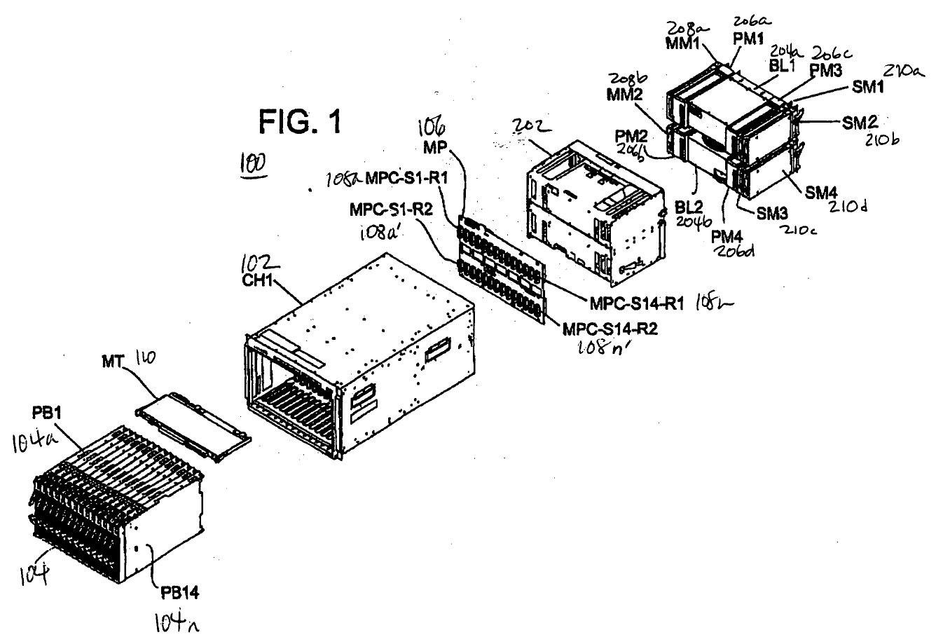

To describe the features of the present invention, please refer to the following discussion and figures, which describe a computer system, such as the BladeCenter, that can be utilized with the present invention. FIG. 1 is an exploded perspective view of the BladeCenter system 100. Referring to this figure, a main chassis 102 houses all the components of the system. Up to 14 server blades 104 (or other blades, such as storage blades) are plugged into the 14 slots in the front of chassis 102. Blades 104 may be “hot swapped” without affecting the operation of other blades 104 in the system 100. A server blade 104a can use any microprocessor technology so long as it is compliant with the mechanical and electrical interfaces, and the power and cooling requirements of the system 100.

A midplane circuit board 106 is positioned approximately in the middle of chassis 102 and includes two rows of connectors 108, 108′. Each one of the 14 slots includes one pair of midplane connectors, e.g., 108a, 108a′, located one above the other, and each pair of midplane connectors, e.g., 108a, 108a′ mates to a pair of connectors (not shown) at the rear edge of each server blade 104a.

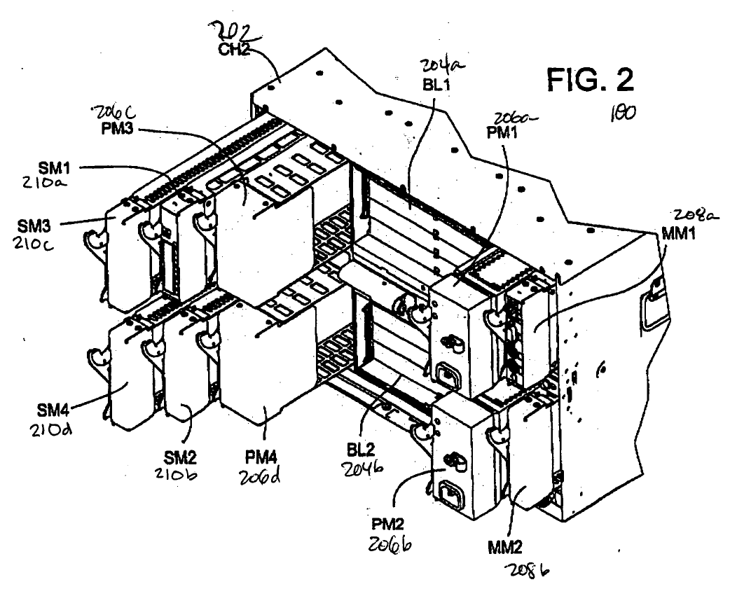

FIG. 2 is a perspective view of the rear portion of the BladeCenter system 100, whereby similar components are identified with similar reference numerals. Referring to FIGS. 1 and 2, a second chassis 202 also houses various components for cooling, power, management and switching. The second chassis 202 slides and latches into the rear of main chassis 102.

As is shown in FIGS. 1 and 2, two optionally hot-plugable blowers 204a, 204b provide cooling to the blade system components. Four optionally hot-plugable power modules 206 provide power for the server blades and other components. Management modules MM1 and MM2 (208a, 208b) can be hot-plugable components that provide basic management functions such as controlling, monitoring, alerting, restarting and diagnostics. Management modules 208 also provide other functions required to manage shared resources, such as multiplexing the keyboard/video/mouse (KVM) to provide a local console for the individual blade servers 104 and configuring the system 100 and switching modules 210.

The management modules 208 communicate with all of the key components of the system 100 including the switch 210, power 206, and blower 204 modules as well as the blade servers 104 themselves. The management modules 208 detect the presence, absence, and condition of each of these components. When two management modules are installed, a first module, e.g., MM1 (208a), will assume the active management role, while the second module MM2 (208b) will serve as a standby module.

The second chassis 202 also houses up to four switching modules SM1 through SM4 (210a-210d). The primary purpose of the switch module is to provide interconnectivity between the server blades (104a-104n), management modules (208a, 208b) and the outside network infrastructure (not shown). Depending on the application, the external interfaces may be configured to meet a variety of requirements for bandwidth and function.

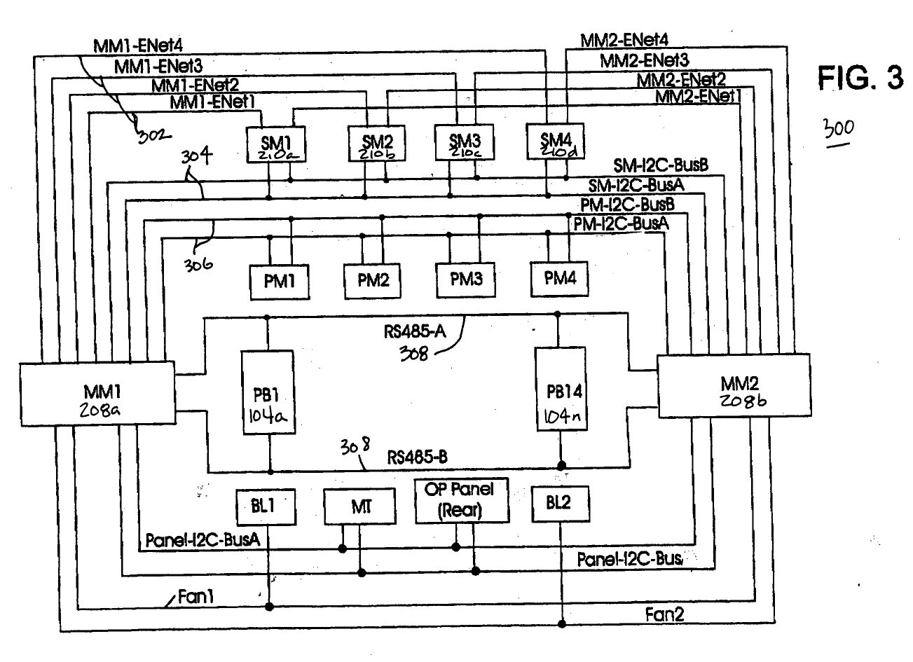

FIG. 3 is a schematic diagram of the server blade system's management subsystem 300, where like components share like identifying numerals. Referring to this figure, each management module (208a, 208b) has a separate Ethernet link (302), e.g., MM1-Enet1, to each one of the switch modules (210a-210d). In addition, the management modules (208a, 208b) are coupled to the switch modules (210a-210d) via two serial 12C buses (304), which provide for “out-of-band” communication between the management modules (208a, 208b) and the switch modules (210a-210d). Two serial buses (308) are coupled to server blades PB1 through PB14 (104a-104n) for “out-of-band” communication between the management modules (208a, 208b) and the server blades (104a-104n).

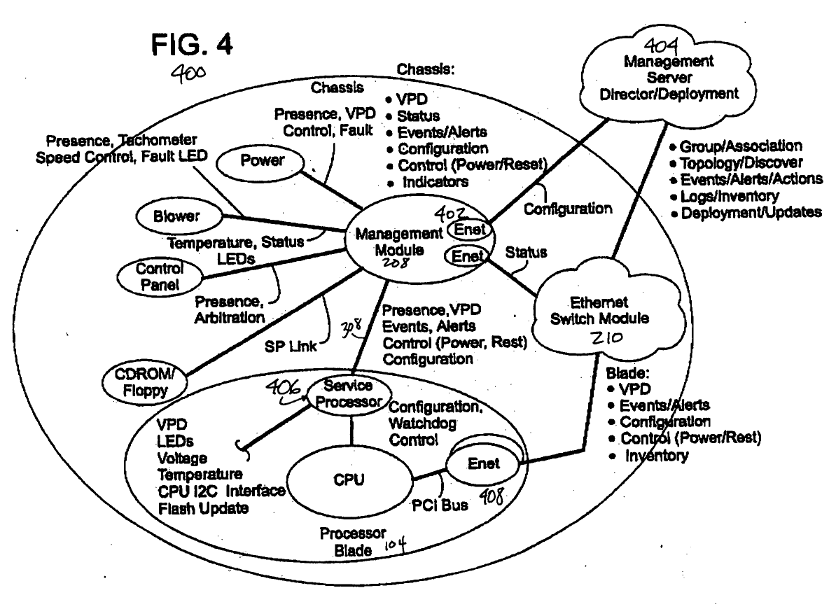

FIG. 4 is a topographical illustration of the server blade system's management functions. Referring to FIGS. 3 and 4, each of the two management modules (208) has an Ethernet port 402 that is intended to be attached to a private, secure management server 404. The management module firmware supports a web browser interface for either direct or remote access. Each server blade (104) has a dedicated service processor 406 for sending and receiving commands to and from the management module 208. The data ports 408 that are associated with the switch modules 210 can be used to access the server blades 104 for image deployment and application management, but are not intended to provide chassis management services. The management module 208 can send alerts to a remote console, e.g., 404, to indicate changes in status, such as removal or insertion of a blade 104 or module. The management module 208 also provides access to the internal management ports of the switch modules 210 and to other major chassis subsystems (power, cooling, control panel, and media drives).

Referring again to FIGS. 3 and 4, the management module 208 communicates with each server blade service processor 406 via the out-of-band serial bus 308, with one management module 208 acting as the master and the server blade's service processor 406 acting as a slave. For redundancy, there are two serial busses 308 (one bus per midplane connector) to communicate with each server blade's service processor 406.

In general, the management module (208) can detect the presence, quantity, type, and revision level of each blade 104, power module 206, blower 204, and midplane 106 in the system, and can detect invalid or unsupported configurations. The management module (208) will retrieve and monitor critical information about the chassis 102 and blade servers (104a-104n), such as temperature, voltages, power supply, memory, fan and HDD status. If a problem is detected, the management module 208 can transmit a warning to a system administrator via the port 402 coupled to the management server 404. If the warning is related to a failing blade, e.g., 104a, the system administrator must replace the failing blade 104a immediately, or at least before the blade fails. That, however, may be difficult because of the inherent delay between the warning and the response. For example, unless the system administrator is on duty at all times, the warning may go unheeded for some time.

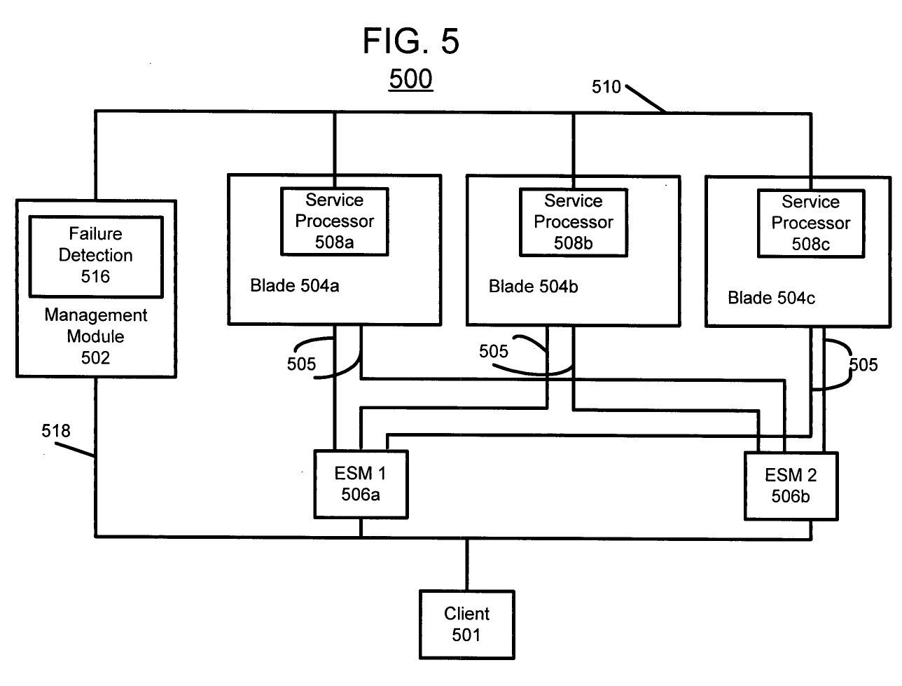

The present invention resolves this problem. Please refer now to FIG. 5, which is a schematic block diagram of the server blade system according to a preferred embodiment of the present invention. For the sake of clarity, FIG. 5 depicts one management module 502, three blades 504a-504c, and two ESMs 506a, 506b. Nevertheless, it should be understood that the principles described below can apply to more than one management module, to more than three blades, and to more than two ESMs or other types of switch modules.

Each blade 504a-504c includes several internal ports 505 that couple it to each one of the ESMs 506a, 506b. Thus, each blade 504a-504c has access to each one of the ESMs 506a, 506b. The ESMs 506a, 506b perform load balancing of Ethernet traffic to each of the server blades 504a-504c. The Ethernet traffic typically comprises TCP/IP packets of data. Under normal operating conditions, when a client 501 requests a session with the server system 500, the ESM, e.g., 506a, handling the request routes the request to one of the server blades, e.g, 504a. An initial TCP handshake is executed to initiate the session between the client 501 and the blade 504a. The handshake comprises three (3) sequential messages: first, a SYN message is transmitted from the client 501 to the blade 504a, in response, the blade 504a transmits a SYN and an ACK message the client 501, and in response to that, the client 501 transmits an ACK message to the blade 504a.

The elapsed time between the first SYN message and the second SYN/ACK message is referred to as a delay time. The ESM 506a tracks and stores the delay time, which can then be used in a load balancing algorithm to perform delay time load balancing among the blades 504a-504c. For example, the typical delay time is in the order of 100 milliseconds. If the delay time becomes greater than the typical value, it is an indication that the blade 504a is overloaded, and the ESM 506a will throttle-down, i.e., redirect, traffic from the overloaded blade 504a to a different blade, e.g., 504b. Under normal circumstances, the delay time for the overloaded blade 504a should decrease. As those skilled in the art realize, different load balancing algorithms may throttle-down at different trigger points or under different circumstances based on the delay time. Because the present invention is not dependent on any particular load balancing algorithm, discussion of such nuances will not be presented.

In addition to being an indication of a blade's load, the delay time can also be used as an indicator of the blade server's health. For example, if the delay time for the blade 504a remains longer than the expected time delay even after the blade's load has been reduced, then there is a high likelihood that the blade 504a is beginning to fail.

In the preferred embodiment of the present invention, a failure detection mechanism 516 is coupled to each of the ESMs 506a, 506b. In one embodiment, the failure detection mechanism 516 is in the management module 502 and therefore utilizes the “out-of-band” serial bus 518 to communicate with each of the ESMs 506a, 506b. In another embodiment, the failure detection mechanism 516 could be a stand alone module coupled to the ESMs 506a, 506b and management module 502, or a module within each ESM 506a, 506b. The failure detection mechanism 516 monitors the delay time for each blade 504a-504c via the ESMs 506a, 506b. If the delay time for a blade 504a exceeds a certain threshold value, e.g., an order of magnitude greater than the expected value of 100 milliseconds and persists even after the traffic to the blade 504a has been throttled-down by the ESM 506a, the failure detection mechanism 516 will transmit a warning message to the system administrator via the management module 502.

The warning message informs the administrator which blade 504a is beginning to fail and prompts the administrator to take appropriate action, e.g., replacement or reboot. Because an increase in the delay time occurs before other degradation indicators, such as a high CPU temperature or voltage measurement, an excessive number of memory errors, or PCI/PCIX parallel bus errors, a potential blade failure can be detected earlier, and corrective action can be taken before the blade actually fails.

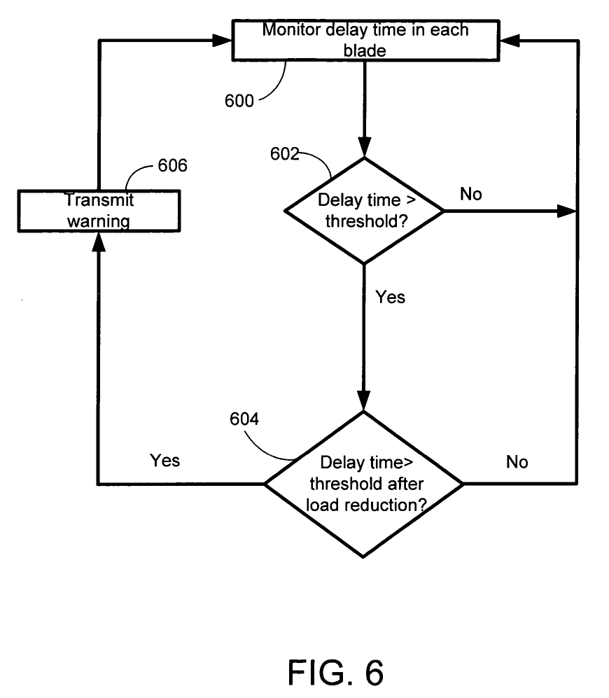

FIG. 6 is a flowchart illustrating a process by which the failure detection mechanism 516 operates according to a preferred embodiment of the present invention. Referring to FIGS. 5 and 6, in step 600, the failure detection mechanism 516 monitors the delay time for each blade server 504a-504c via each ESM 506a, 506b. If the delay time for a blade, e.g., 504a, exceeds a threshold value (step 602), e.g., the delay time is greater than one (1) second, and if the delay time continues to exceed the threshold value even after the ESM, e.g., 506a, has reduced the load to the blade 504a (step 604), then the failure detection mechanism transmits a warning message to the system administrator (step 606). If the delay time for the blade does not exceed the threshold (step 602) or if the delay time improves, e.g., decreases below the threshold value, after the load has been reduced (step 604), then the failure detection mechanism continues monitoring (step 600).

A method and system for early failure detection in a server has been described. According to a preferred embodiment of the present invention, a failure detection mechanism 516 coupled to each of a plurality of switch modules 506a, 506b monitors load balancing data collected by the switch modules 506a, 506b. By monitoring such data for each of the plurality of servers, the failure detection mechanism can detect a failing server early and initiate protective and/or preventive measures, e.g., transmitting a warning message to an administrator, long before the server actually fails.

While the preferred embodiment of the present invention has been described in the context of a BladeCenter environment, the functionality of the failure detection mechanism 516 could be implemented in any computer environment where the servers are closely coupled. Thus, although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for detecting a failing server of a plurality of servers comprising:
a) monitoring load balancing data for each of the plurality of servers via at least one switch module; and
b) determining whether a server is failing based on the load balancing data associated with the server.

2. The method of claim 1, further comprising the step of:
c) transmitting a warning message if the server is failing.

3. The method of claim 1, wherein the load balancing data comprises a delay time between a first message from a client to a server and a second message from the server to the client in response to the first message.

4. The method of claim 1, wherein the load balancing data comprises a server's response time during an initial TCP handshake.

5. The method of claim 3, wherein the determining step (b) further comprises:
(b1) determining whether the delay time exceeds a threshold value.

6. The method of claim 5, wherein the threshold value is at least an order of magnitude greater than an expected delay time in seconds.

7. The method of claim 5, wherein the determining step (b) further comprises:
(b2) if the delay time does exceed the threshold value, determining whether the delay time exceeds the threshold value after traffic to the server has been reduced.

8. The method of claim 7, wherein if the delay time exceeds the threshold value after traffic to the server has been reduced, the server is failing.

9. A computer readable medium containing a program for detecting a failing server of a plurality of servers, comprising instructions for:
a) monitoring load balancing data for each of the plurality of servers via at least one switch module; and
b) determining whether a server is failing based on the load balancing data associated with the server.

10. The computer readable medium of claim 9, further comprising the instruction for:
c) transmitting a warning message if the server is failing.

11. The computer readable medium of claim 9, wherein the load balancing data comprises a delay time between a first message from a client to a server and a second message from the server to the client in response to the first message.

12. The computer readable medium of claim 9, wherein the load balancing data comprises a server's response time during an initial TCP handshake.

13. The computer readable medium of claim 11, wherein the determining instruction (b) further comprises:
(b1) determining whether the delay time exceeds a threshold value.

14. The computer readable medium of claim 13, wherein the threshold value is at least an order of magnitude greater than an expected delay time in seconds.

15. The computer readable medium of claim 13, wherein the determining instruction (b) further comprises:
(b2) if the delay time does exceed the threshold value, determining whether the delay time exceeds the threshold value after traffic to the server has been reduced.

16. The computer readable medium of claim 15, wherein if the delay time exceeds the threshold value after traffic to the server has been reduced, the server is failing.

17. A system for detecting a failing server of a plurality of servers comprising:
at least one switch module coupled to the plurality of servers; and
a failure detection mechanism coupled to each of the plurality of switch modules, wherein the failure detection mechanism monitors load balancing data for each of the plurality of servers via the at least one switch module and determines whether a server is failing based on the load balancing data associated with the server.

18. The system of claim 17, wherein the failure detection mechanism transmits a warning message if the server is failing.

19. The system of claim 17, wherein the load balancing data comprises a delay time between a first message from a client to a server and a second message from the server to the client in response to the first message.

20. The system of claim 17, wherein the load balancing data comprises a server's response time during an initial TCP handshake.

21. The system of claim 19, wherein the failure detection mechanism further determines whether the delay time exceeds a threshold value.

22. The system of claim 21, wherein the threshold value is at least an order of magnitude greater than an expected delay time in seconds.

23. The system of claim 21, wherein the at least one switch module executes a load balancing algorithm that reduces traffic to a server based on the delay time.

24. The system of claim 23, wherein the failure detection mechanism further determines whether the delay time for a server exceeds the threshold value after traffic to the server has been reduced, wherein if the delay time exceeds the threshold value after traffic to the server has been reduced, the server is failing.

25. A computer system comprising:
a plurality of servers;
at least one switch module coupled to the plurality of servers;
a management module coupled to each of the plurality of servers and to each of the at least one switch modules; and
a failure detection mechanism coupled to the management module, wherein the failure detection mechanism monitors load balancing data for each of the plurality of servers via the at least one switch module and determines whether a server is failing based on the load balancing data associated with the server.

26. The system of claim 25, wherein the failure detection mechanism causes the management module to transmit a warning message if the server is failing.

27. The system of claim 25, wherein the load balancing data comprises a delay time between a first message from a client to a server and a second message from the server to the client in response to the first message.

28. The system of claim 25, wherein the load balancing data comprises a server's response time during an initial TCP handshake.
